(19) United States
(12) Patent Application Publication
(10) Pub. No.: US 2005/0278905 A1
(43) Pub. Date: Dec. 22, 2005

(54) Toggle clamp assist tool

(75) Inventors: Thom Zawerucha, Caro, MI (US); Phillip Marn, Rochester, MI (US)

Correspondence Address: James A. Wilke;Foley & Lardner, Suite 3800, 777 East Wisconsin, Milwaukee, WI, 53202-5306, US

(73) Assignee: Eagle Ottawa, LLC

(21) Appl. No.: 10/773,725

(22) Filed: Feb. 5, 2004

(51) Int. Cl. A44B 11/25; A44B 21/00; B42F 1/00; A41F 1/00

(52) U.S. Cl. 24/457

(57) ABSTRACT

A method and apparatus of a toggle clamp assist tool for a toggle clamp having a clamp jaw, clamp arm, and a clamp loop. The toggle clamp assist tool comprises a base member. A clamp pin coupled to the base and configured to engage the clamp loop of the toggle clamp. An actuator is mounted on the base and configured to contact the clamp arm of the toggle clamp. A controller is coupled to the actuator, wherein the actuator is selectively in contact with the clamp arm of the toggle clamp when the controller is activated. The actuator may be one of a fluid cylinder and an electric apparatus.

### BACKGROUND OF THE INVENTION

The present invention relates to the process of treating leather hides, and more particularly to an apparatus and method manipulating a work piece using a toggle clamp with a toggle clamp assist tool.

Toggling drying is a process used in the leather industry by which a hide is stretched over a rack having a plurality of holes and holding the hide (work piece) in place with a clamp, commonly known as a toggle clamp. Once the hide has been stretched and held in place with the toggle clamps, the rack is then transferred into a low temperature oven and the hide is dried.

The common or current practice of applying the toggle clamp to the work piece requires an operator to place an index finger through a loop on the back of the toggle clamp, then by use of the operator's thumb pressing downward on the clamp arm to open the clamp jaw. At this point, the operator places the toggle clamp onto the leather work piece and releases the thumb pressure to close the clamp jaw. With the clamp jaw closed, the operator then pulls the clamp by use of the operator's index finger, back or towards the operator to stretch or tighten the leather work piece. Once the leather work piece has been stretched or tightened, the operator then places the holding pin, which is attached to and located on the bottom side of the toggle clamp, into one of the holes in the perforated rack. Typically, multiple toggle clamps are required to stretch a hide.

The process of applying the toggle clamps to the hides, causes several ergonomic issues. The repetitive acts of pressing downward with the thumb to open the clamp jaw, may cause thumb sprains, carpal tunnel syndrome, tendonitis and thumb fatigue. The use of the index finger to hold and pull back on the toggle clamp may also cause finger sprain, carpal tunnel syndrome and tendonitis. There is also the potential to cause damage to the operator's knuckles on the middle, ring and pinky fingers by dragging the fingers across the perforated rack while pulling the toggle clamp back to tighten or stretch the leather.

Thus, there is a need for a toggle clamp assist tool that will minimize strain on the fingers and thumb of an operator in a leather treatment process. There is a further need for a method to stretch leather work pieces using toggle clamps with minimal operator thumb and finger strain.

### SUMMARY OF THE INVENTION

There is provided a toggle clamp assist tool for a toggle clamp having a clamp jaw, clamp arm, and a clamp loop. The toggle clamp assist tool comprises a base member. A clamp pin coupled to the base and configured to engage the clamp loop of the toggle clamp. An actuator is mounted on the base and configured to contact the clamp arm of the toggle clamp. A controller is coupled to the actuator, wherein the actuator is selectively in contact with the clamp arm of the toggle clamp when the controller is activated. The actuator may be one of a fluid cylinder and an electric apparatus.

There is also provided a method of manipulating a work piece with a toggle clamp and a leather treatment process with a toggle clamp assist tool having a base member, a clamp pin, an actuator, and a controller coupled to the actuator. The toggle clamp has a clamp jaw, a clamp arm, a clamp loop and toggle pin and an associated rack having a plurality of holes configured to engage the toggle pin. The method comprises the steps of placing the clamp loop on the clamp pin of the toggle clamp assist tool. Manipulating the controller to activate the actuator to open the clamp jaw of the toggle clamp. Placing the work piece in the clamp jaw of the toggle clamp. Manipulating the controller to activate the actuator to close the clamp jaw of the toggle clamp onto the work piece. Pulling the toggle clamp assist tool a predetermined distance, and inserting the toggle pin into one of the holes, in the rack. Another embodiment of the method includes the steps of repeating each of the steps described above with a second toggle clamp assist tool. Another embodiment includes the steps of repeating each of the steps described above with each of not less than three toggle assist tools.

There is additionally provided a toggle clamp assist tool for a toggle clamp having a clamp jaw, clamp arm, and clamp loop. The toggle clamp assist tool comprises a means for supporting. A means for engaging coupled to the means for supporting and configured to engage the clamp loop of the toggle clamp. A means for actuating is mounted on the means for supporting and configured to contact the clamp arm of the toggle clamp. A means for controlling is coupled to the means for actuating, wherein the means for engaging is selectively in contact with the clamp arm of the toggle clamp when the means for controlling is activated. Another embodiment of the toggle clamp assist tool includes a means for holding mounted on the means for supporting and configured to support the means for controlling.

### BRIEF DESCRIPTION OF THE DRAWINGS

FIG. 1 is a top plan view of an exemplary embodiment of a toggle clamp assist tool coupled to a work piece, for example a leather hide, on a toggle rack for a leather treatment process.

FIG. 2 is a side plan view illustration of a toggle clamp with an operator index finger engaged in a clamp loop in accord with prior art practice.

FIG. 3 is a side plan view of an exemplary embodiment of a toggle clamp assist tool coupled to a toggle clamp.

FIG. 4 is a sectional view of the toggle clamp assist tool in toggle clamp illustrated in FIG. 3 along the line 4-4.

FIG. 5 is a sectional view of the toggle clamp assist tool in toggle clamp illustrated in FIG. 3 along the line 5-5.

### DETAILED DESCRIPTION OF THE EXEMPLARY EMBODIMENTS

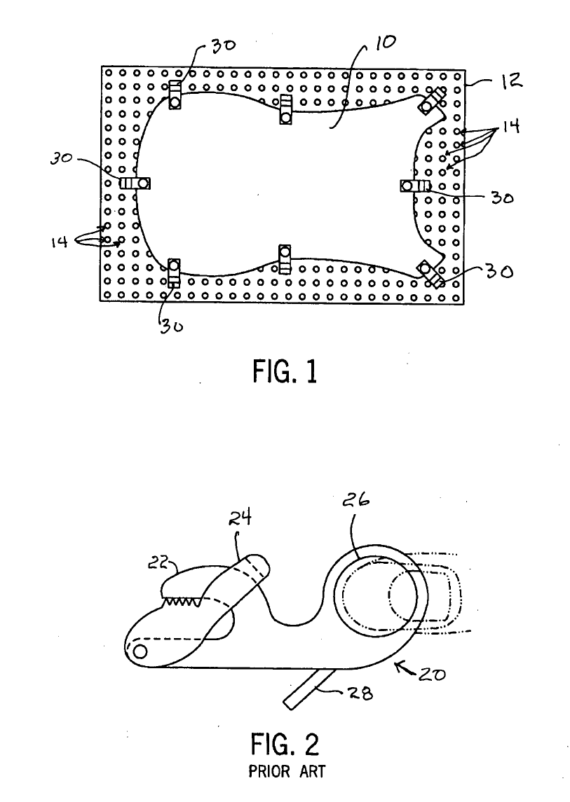

Referring to FIGS. 1 and 2, there is illustrated in FIG. 1 a leather treatment process rack 12 which is configured with a plurality of holes 14. A work piece 10, for example a leather hide, is stretched on the rack 12 during the leather treatment process. The stretching of the hide 10 is typically performed by a series of toggle clamps 20 coupled to the hide and stretched on the rack 12. FIG. 2 illustrates a prior art practice of toggle clamp usage.

The toggle clamp 20 includes a toggle loop 26 at one end and a clamp jaw 22 at another end. A clamp arm 24, which typically is spring biased, is depressed to open the toggle clamp 20 to grip the work piece 10. An operator's thumb is typically used to depress the clamp arm 24. The operator's thumb must overcome the force of the spring bias against the clamp arm 24 which can cause thumb sprains, tendonitis and thumb fatigue. An operator then typically, using the same hand, will engage the clamp loop 26 of the toggle clamp 20 with the operator's index finger as illustrated in FIG. 2. The operator then pulls the toggle clamp 20 which is clamped to a portion of the work piece 10 to stretch the work piece a preselected distance. The operator will then insert the toggle pin 28 into one of the holes 14 in the rack 12. The operator will repeat that process around the perimeter of the work piece until the work piece is appropriately stretched for continued processing in the leather treatment process. Such action by an operator, the use of the index finger to hold and pull back on the clamp, can cause finger sprain, carpal tunnel syndrome, and tendonitis. In addition, the action of pulling the toggle clamp 20 back over the holes 14 of the rack 12 can damage the operator's knuckles, typically on the middle, ring and pinkie fingers during the pulling and stretching action.

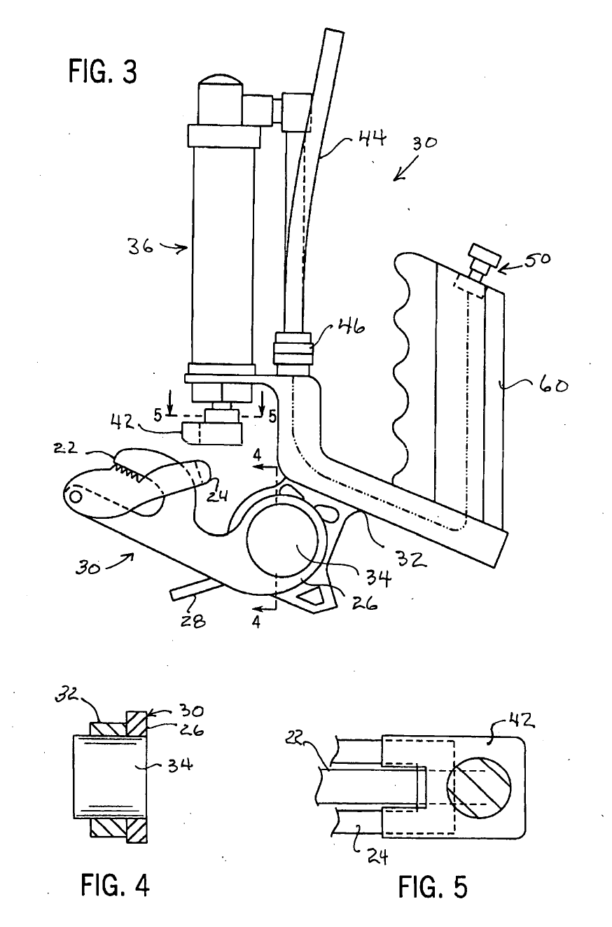

To alleviate the above-described problems with the prior art use of a toggle clamp, there is disclosed a toggle clamp assist tool 30 as illustrated in FIG. 3. The toggle clamp assist tool 30 includes a base member 32 having a clamp pin 34. A handle 60 is coupled to the base member 32. An actuator 36 is coupled to the base member 32 and configured to selectively contact the clamp arm 24 of the toggle clamp 20 which will be described below.

The base member 32 of the toggle clamp assist tool 30 can be composed of plastic or metal having sufficient strength and durability for its intended use. The base member 32 can be molded, or machined. The base member 32 is configured to support the clamp pin 34 which is coupled to the base member 32.

The clamp pin 34 is configured to engage the clamp loop 26 of the toggle clamp 20. It is contemplated that the clamp pin 34 can be configured to frictionally retain the toggle clamp 20 or include a fastener such as a cotter pin or threaded nut.

The base member 32 also supports an actuator 36 which is mounted on the base and configured to contact the clamp arm 24 of the toggle clamp 20. The actuator can be a fluid cylinder, for example a pneumatic cylinder or a hydraulic cylinder, or the actuator 36 can be an electric apparatus, for example an electric motor or a solenoid. A portion or member of the actuator 36 extends to selectively contact the clamp arm 24. The actuator 36 is controlled by a controller 50 which is conveniently mounted on the handle 60 of the toggle clamp assist tool 30. The controller 50 can be a valve or a switch coupled to the actuator 36. For example, if the actuator is a fluid cylinder, the controller 50 typically would be a button actuated valve. If the actuator 36 is an electric apparatus, the controller 50 typically would be an electric switch also mounted on the handle 60.

When the controller 50 activates the actuator 36, the actuator selectively contacts the clamp arm 24 of the toggle clamp 20 to push the clamp arm 24 to an open position. When the controller 50 deactivates the actuator 36 the actuator disengages from the clamp arm 24 and the bias member of the toggle clamp 20 closes the clamp arm 24 against the clamp jaw 22 to secure the work piece 10.

The base member 32 also typically will support an energy line 44 which is coupled to the actuator 36 and controller 50 by a line coupler 46. The energy line 44 can be a fluid line, such as an air line or a hydraulic line or a wire to convey electrical energy. As will be appreciated, the type of energy line 44 is dependent upon the type of actuator 36 and controller 50 utilized on the toggle clamp assist tool 30. It is also contemplated that the base member 32 can be configured to support an energy source for the actuator 36 that does not require the toggle clamp assist tool 30 from being tethered to a central energy supply. For example, the toggle clamp assist tool 30 can support an electric battery to supply electrical power to an electric motor or solenoid. Alternatively, the toggle clamp assist tool 30 can be configured to support a cylinder of compressed gas to operate a pneumatic type actuator 36.

In operation, a method of manipulating a work piece 10 with a toggle clamp 20 in a leather treatment process with a toggle clamp assist tool 30 will be described. An operator would place the clamp loop 26 of the toggle clamp 20 on the clamp pin 34 of the toggle clamp assist tool 30. The operator would manipulate the controller 50 to activate the actuator 36 to open the clamp jaw 22. The operator would place the work piece 10 in the toggle clamp 20 between the clamp jaw 22 and the open clamp arm 24. The operator would manipulate the controller 50 to activate the actuator to close the clamp jaw 22 onto the work piece 10. The operator would pull the toggle clamp assist tool 30 a predetermined distance using the operator's hand (rather than just a finger) and inserting the toggle pin 28 of the toggle clamp 20 into one of the holes 14 in the rack 12. An operator could repeat the above-described steps with a second toggle clamp assist tool 30. The operator could repeat each of the above-described steps with a three or more toggle clamp assist tools 30.

It is also contemplated that a single toggle clamp assist tool 30 would be utilized with a plurality of toggle clamps 20. In such instance, an operator would couple a toggle clamp 20 to the toggle clamp assist tool 30, engage the work piece 10, stretch the work piece and insert the toggle pin 28 into a hole 14 of the rack 12. The operator would disengage the toggle clamp assist tool 30 from that toggle clamp 20, couple a second toggle clamp 20 to the toggle clamp assist tool 30, engage a different portion of the work piece 10 and repeat the stretching and pinning process. The operator would repeat such procedure as the operator proceeded around the work piece 10 to obtain that which is illustrated, for example, in FIG. 1.

It is important to note that the construction and arrangement of elements of the toggle clamp assist tool with the actuator as described is illustrative only. Although only a few embodiments of the toggle clamp assist tool have been described in detail in this disclosure, one skilled in the art, upon review of this disclosure, will verily appreciate that many modifications are possible (example: variations in sizes, dimensions, shapes and proportion of the various elements, values and parameters, mounting arrangements, use of materials, orientations, etc.) without materially departing from a novel teachings and advantages of the subject matter disclosed herein. Accordingly, all such modifications are intended to be included within the scope of the present disclosure. The order of sequence of any process or method steps may be varied or resequenced according to alternative embodiments. Other substitutions, modifications, changes and omissions may be made in the design, operating condition and arrangement of the exemplary embodiments without departing from the spirit of the appended claims.

1. A toggle clamp assist tool for a toggle clamp having a clamp jaw, clamp arm, and clamp loop, the toggle clamp assist tool comprising:
a base member;
a clamp pin coupled to the base and configured to engage the clamp loop of the toggle clamp;
an actuator mounted on the base and configured to contact the clamp arm of the toggle clamp; and
a controller coupled to the actuator,
wherein the actuator is selectively in contact with the clamp arm of the toggle clamp when the controller is activated.

2. The toggle clamp assist tool of claim 1, wherein the actuator is one of a fluid cylinder and an electric apparatus.

3. The toggle clamp assist tool of claim 2, wherein the fluid cylinder is one of a pneumatic cylinder and a hydraulic cylinder.

4. The toggle clamp assist tool of claim 2, wherein the electric apparatus of one of an electric motor and a solenoid.

5. The toggle clamp assist tool of claim 1, including a handle mounted on the base and configured to support the controller.

6. The toggle clamp assist tool of claim 1, wherein the controller is one of a valve and a switch.

7. The toggle clamp assist tool of claim 5, wherein one of the base and handle is composed of plastic.

8. The toggle clamp assist tool of claim 5, wherein one of the base and handle is composed of metal.

9. A method of manipulating a work piece with a toggle clamp in a leather treatment process with a toggle clamp assist tool having a base member, a clamp pin, an actuator, and a controller coupled to the actuator, the toggle clamp having a clamp jaw, clamp arm., clamp loop and toggle pin, and an associated rack having a plurality of holes configured to engage the toggle pin, the method comprising the steps of:
placing the clamp loop on the clamp pin of the toggle clamp assist tool;
manipulating the controller to activate the actuator to open the clamp jaw;
placing the work piece in the clamp jaw;
manipulating the controller to activate the actuator to close the clamp jaw onto the work piece;
pulling the toggle clamp assist tool a predetermined distance; and
inserting the toggle pin into one of the holes in the rack.

10. The method of claim 9, including the steps of repeating each of the 16 steps of claim 8 with a second toggle clamp assist tool.

11. The method of claim 9, including the steps of repeating each of the steps of claim 8 with each of not less than three toggle clamp assist tools.

12. The method of claim 9, wherein the actuator is one of a fluid cylinder and an electric apparatus.

13. The method of claim 12, wherein the fluid cylinder is one of a pneumatic cylinder and a hydraulic cylinder.

14. The method of claim 12, wherein the electric apparatus is one of an electric motor and a solenoid.

15. The method of claim 9, wherein the toggle assist tool includes a handle mounted on the base and configured to support the controller.

16. The method of claim 9, wherein the controller is one of a valve and a switch.

17. The method of claim 15, wherein one of the base and handle is composed of plastic.

18. The method of claim 15, wherein one of the base and handle is composed of metal.

19. A toggle clamp assist tool for a toggle clamp having a clamp jaw, clamp arm, and clamp loop, the toggle clamp assist tool comprising:
a means for supporting;
a means for engaging coupled to the means for supporting and configured to engage the clamp loop of the toggle clamp;
an means for actuating mounted on the means for supporting and configured to contact the clamp arm of the toggle clamp; and
a means for controlling coupled to the means for actuating,
wherein the means for engaging is selectively in contact with the clamp arm of the toggle clamp when the means for controlling is activated.

20. The toggle clamp assist tool of claim 19, wherein the means for actuating is one of a fluid cylinder and an electric apparatus.

21. The toggle clamp assist tool of claim 19, including a means for holding mounted on the means for supporting and configured to support the means for controlling.
